(19) United States
(12) Patent Application Publication
(10) Pub. No.: US 2011/0049920 A1
(43) Pub. Date: Mar. 3, 2011

(54) TOOL HANDLE

(75) Inventors: Lawrence E. Guerra, Mission, KS (US); Kent R. Erickson, Overland Park, KS (US)

(73) Assignee: NICOLAY FAMILY ENTERPRISES, L.L.C., Fairway, KS (US)

(21) Appl. No.: 12/859,844

(22) Filed: Aug. 20, 2010

Related U.S. Application Data
(60) Provisional application No. 61/236,769, filed on Aug. 25, 2009.

(51) Int. Cl. A01B 1/02; B25G 1/00

(52) U.S. Cl. 294/58

(57) ABSTRACT

A handle assembly is disclosed for tools such as shovels and the like having a primary handle and an auxiliary handle. The primary handle includes first and second legs, each of which has a first end which is securable to a tool head such that the first and second legs extend outwardly from the tool head in generally parallel relation to one another. A primary grip or handlebar extends between the legs at the ends opposite the tool head. The auxiliary handle is slidably connected to said first and second legs so as to be moveable toward and away from the primary grip. The auxiliary handle is removably connectable to the legs and may be stored in a generally planar alignment between the legs to facilitate stacking or the auxiliary handle may be shaped to facilitate nesting of adjacent auxiliary handles of stacked handle assemblies.

### CROSS-REFERENCE TO RELATED APPLICATIONS

This application claims the benefit of U.S. provisional patent application Ser. No. 61/236,769, filed Aug. 25, 2009, under 35 U.S.C. §119(e).

### BACKGROUND OF THE INVENTION

1. Field of the Invention

This invention relates to an improved handle for use on tools such as shovels and the like.

2. Description of the Related Art

Tools such as shovels (including snow shovels, spades, and scoops), forks and the like typically have handles comprising a single straight shaft which is secured to a head of the tool along a central axis of the tool head. One problem with such tool handles arises when the user must lift the tool head off of the ground in order to dump or expel a load therefrom. To lift the tool, the user must bend over at the waist, grasp the handle near the tool head, and lift the tool using his back. Lifting with the back in this manner often causes strain or injury to the user's back. Previous attempts to address this problem include U.S. Pat. Nos. 5,499,852, 5,921,600 and 6,062,619, which describe auxiliary handles for attachment to a single shaft tool handle, the auxiliary handles being intended to extend upwardly from the primary tool handle shaft so that the user does not have to bend over as far in order to lift the tool head. In addition, U.S. Pat. No. 171,325 discloses a drag rake handle having a pair of limbs mounted at an acute angle to one another and having an auxiliary handle mounted between the limbs. The auxiliary handle may be mounted so as to extend upwardly from the limbs.

None of these previous attempts to provide tool handles which facilitate lifting appear to have gained widespread use, and therefore there remains a need for an ergonomically designed tool handle which is relatively easy to use and which facilitates lifting.

### SUMMARY OF THE INVENTION

The present invention comprises a handle for tools such as shovels and the like. The handle includes first and second legs, each of which has a first end which is securable to a tool head such that the first and second legs extend outwardly from the tool head in generally parallel relation to one another. The tool head may include a first and second mounting sleeves disposed on opposite sides of the tool head for mounting the first ends of the first and second legs. A handlebar or primary grip is connected between the second ends of the first and second legs. A lower handle or auxiliary handle is slidably connected to said first and second legs so as to be moveable toward and away from the handlebar.

The auxiliary handle assembly comprises a first and second mounting member each having a semi-enclosed base and a support arm extending therefrom. The support arms of each mounting member secure the auxiliary handle therebetween. The semi-enclosed base of each mounting member receives a middle portion of the respective first or second leg and is removably connectable to the first and second legs. When the auxiliary handle is connected thereto, the support arms, and connected auxiliary grip, extends outward from a plane defined by the first and second legs. A pin or slide lock is provided for selectively securing the auxiliary handle to the first and second legs. The auxiliary handle may be removed from the perpendicular or transverse alignment with the legs and stored between the legs prior to sale to facilitate shipping and display.

Alternatively the auxiliary handle may be shaped to allow the tool handle assemblies to be stacked on top of each other with lower handles of adjacent tool handle assemblies nested together, one within the other.

### BRIEF DESCRIPTION OF THE DRAWINGS

FIG. 1 is a perspective view of a shovel with a tool handle assembly of the present invention.

FIG. 2 is an enlarged, fragmentary and exploded perspective view of the tool handle assembly.

FIG. 3 is a perspective view of the shovel with an alternative embodiment of the auxiliary handle.

FIG. 4 is a front plan view of the shovel as shown in FIG. 3 showing the auxiliary handle removed from a perpendicular alignment and stored between spaced apart legs of the tool handle assembly.

FIG. 5 is a side view showing two tool handle assemblies stacked together with the auxiliary handles of adjacent tool handle assemblies nested together.

FIG. 6 is a cross-sectional view taken along line 6-6 of FIG. 5.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

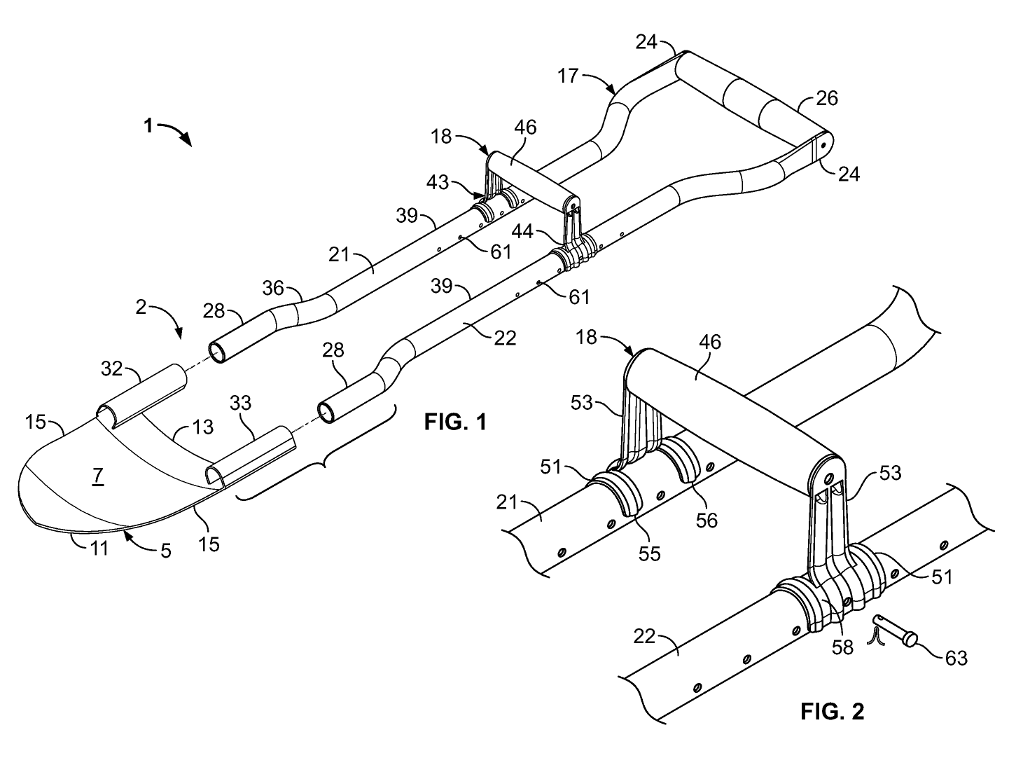

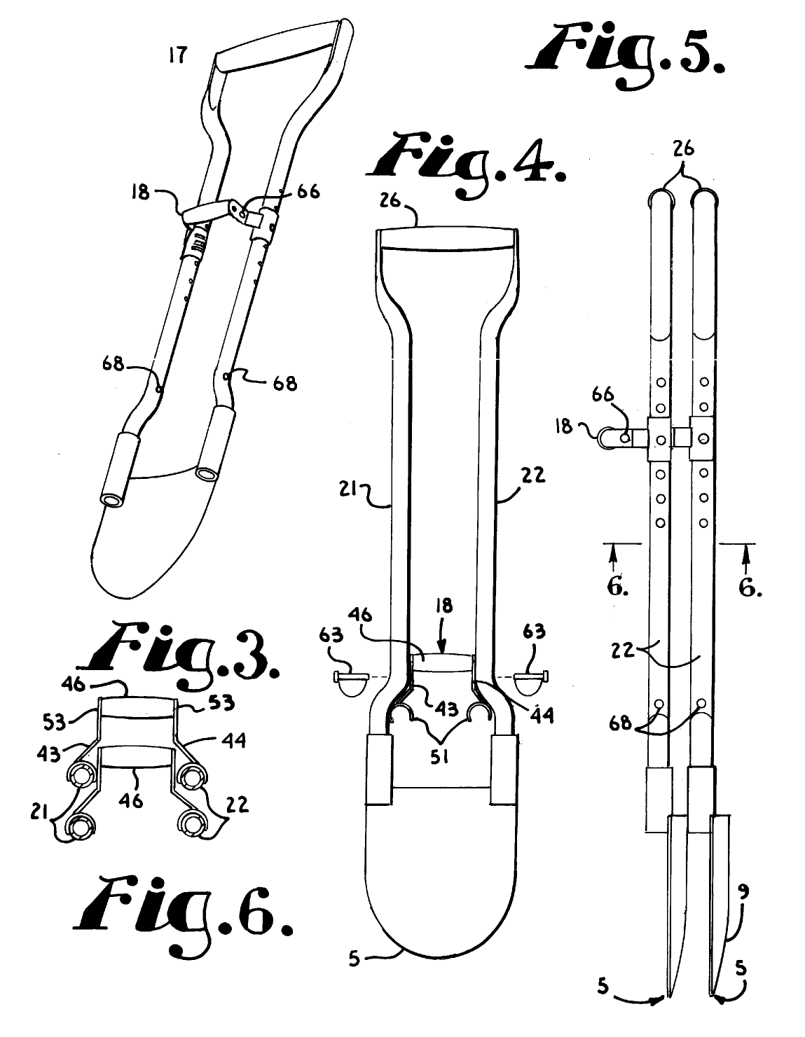

Referring to the drawings in more detail, the reference number 1 generally designates a tool handle assembly embodying the present invention. The handle 1 is shown in FIGS. 1-4 as being part of a spade or shovel 3 having a conventional shovel blade 5. The blade 5 includes a front surface 7, a rear surface 9, a lower edge 11, an upper edge 13, and opposed side edges 15. It is to be understood, however, that the handle 1 is easily adaptable for use on various types of shovels including snow shovels and scoop shovels, as well as on other types of tools such as forks, rakes, brooms and the like having tool heads other than shovel blades.

Referring to FIG. 1, the handle assembly 1 generally comprises a primary handle 17 and an auxiliary handle 18. Primary handle 17 includes first and second spaced apart legs 21 and 22. The legs are connected at respective first or upper ends 24 by an upper or primary grip 26, which may be formed of wood or plastic and bolted in place between the legs 21 and 22. The portion of the tubing forming the legs 21 and 22 as shown is flattened at the upper ends 24 to facilitate connection of the upper grip 26 therebetween.

Each of the legs 21 and 22 has a tool head attachment portion 28 at a second end thereof opposite the first end 24. The attachment portions 28 are connectable to the blade 5 by conventional means such as screws, bolts, rivets, spot welding, removable pins or the like such that the legs 21 and 22 extend upwardly or outwardly past the upper edge 13 of the blade 5 in parallel spaced relation to one another. The blade 5 as shown may have a pair of handle mounting sleeves 32 and 33 formed or mounted on the blade 5 by welding or the like proximate opposed side edges 15 to receive the lower end 30 of a respective leg 21 or 22. The leg may then be secured in place in the sleeve by well known fastening means including screws, bolts, rivets, removable pins, spot welding or the like. Use of removable pins or other releaseable securement means would permit use of the tool handle assembly 1 with different tool heads including different types of shovels, rakes, brooms, hoes and scrapers.

The attachment portions 28 are preferably connected to the blade 5 proximate its side edges 15. In the embodiment shown the attachment portions of the legs are shown attached to the front surface 7 of the blade. It is foreseen that the attachment portions could be attached to the rear surface 9, such as for a snow shovel, or along the side edges 15. As shown, the legs 21 and 22 include an inwardly offset section 36, above the upper edge 13 of the blade 5, which space the legs 21 and 22 closer together than the attachment portions 28. The attachment portions 28 should not be spaced any closer to one another than will allow a user to easily insert a foot therebetween to push down on the upper edge 13 of the blade 5.

The legs 21 and 22 also flare outward proximate the upper ends 24 thereof to accommodate the upper grip 26 and to provide sufficient spacing therebetween to comfortably accommodate the hand of a user. Medial portions 39 of the legs 21 and 22 are straight and extend in parallel, spaced apart relation to one another.

The lower or auxiliary handle 18 is slidably securable to the legs 21 and 22. Auxiliary handle 18 includes mounting members 43 and 44 and auxiliary grip 46 which is bolted to and between the mounting members 43 and 44. Each mounting member 43 and 44 shown is stamped from a single piece of sheet metal to form a semi-enclosed or semi-cylindrical base 51 and a support arm 53 projecting outward therefrom. The base 51 includes first and second curved fingers 55 and 56 extending in a first direction on opposite sides of the support arm 53 (which may also be described as a middle finger) and a curved palm portion 58 extending in a second direction relative to the curved fingers 55 and 56. The fingers 55 and 56 and the palm portion 58 extend circumferentially approximately 180 degrees or slightly greater so that the base 51 may be secured around an associated leg 21 or 22 and slide relative thereto.

The position of the auxiliary handle 18 relative to the legs 21 and 22 is adjustable to accommodate users of various sizes by sliding the mounting members 43 and 44 up or down the legs 21 and 22. A plurality of longitudinally spaced holes 61 are formed in each leg 21 and 22 and selectively alignable with one or more holes in the base 51 of the mounting members 43 and 44. The position of the auxiliary handle 18 relative to the legs 21 and 22 may be fixed using a locking pin 63 removably positionable through aligned holes in the mounting members 43 and 44 and in the legs 21 and 22.

When secured to the legs 21 and 22 with the base 51 of each mounting member 43 and 44 secured around an associated leg, the support arms 53 project upward from a plane extending through the medial portions 39 of the spaced apart legs 21 and 22. The auxiliary grip 46 is then connected between the distal ends of each support arm 53 and spaced above the plane extending through the legs 21 and 22. The auxiliary grip 46 extends perpendicular or generally transverse to the legs 21 and 22.

In use, the auxiliary handle 18 serves to make the shovel 3 much easier to lift than is the case with a conventional shovel. The user of a conventional shovel must bend substantially at the waist in order to reach down and grip the handle of the shovel near the blade so that he can lift the shovel and throw the contents of the blade out of the way. Because the user must reach down so far to grab the handle, it is difficult for the user to bend at the knees to facilitate lifting with his legs. The user is, therefore, forced to lift with his back, which will often result in back strain. With the shovel of the present invention, however, the user can grasp the lower or auxiliary handle 18 without bending over nearly as far at the waist. He is then able to bend at the knees to get in position to lift with his legs, sparing unnecessary injury or strain to his back.

The dual legs 21 and 22 of the handle 1 also act to make the shovel 3 easier to use than a conventional shovel. When a user lifts a conventional shovel with a load supported on the blade, the weight of the load is often unbalanced and tends to create a torsional force on the handle. If the user does not grip the handle sufficiently tightly, this torsional force will cause the shovel to rotate or roll about its handle, thereby spilling the load. Constantly gripping the handle tightly enough to offset this torsional force adds to the user's fatigue. The dual legs 21 and 22 of the present invention move the supports for the blade 5 and the load supported thereon outwardly, thereby providing a lever arm which helps to counter the rotational forces.

Auxiliary handle 18 is preferably removably securable to the legs 21 and 22 so that it does not interfere with stacking of multiple handle assemblies 1 or shovels 3 for transport or display. Referring to the embodiment shown in FIGS. 3-6, the auxiliary grip 46 and mounting members 43 and 44 of auxiliary handle 18 may be sized and shaped to be positioned with the grip 46 extending between the legs 21 and 22 and the support arms 53 of each mounting member 43 and 44 extending inside of the legs 21 and 22 proximate the inwardly offset sections 36 thererof. One or more holes 66 may be formed in each of the support arms 53 which can be aligned with corresponding holes 68 formed in the legs 21 and 22 proximate the offset sections 36 so that the pins 63 may be used to removably secure the auxiliary handle 18 between the legs 21 and 22 as shown such that the auxiliary grip 46 generally extends in planar alignment with the first and second legs 21 and 22.

The tool handle assembly 1 can then be shipped or stored on store displays with the auxiliary handle 18 positioned between and generally in planar alignment with the legs 21 and 22 to facilitate stacking of multiple shovels 3 or the like. The purchaser can then remove the auxiliary handle 18 from the stored position and attach it in a perpendicular alignment with the legs 21 and 22 as described above.

Referring to FIGS. 5 and 6, it is also foreseen that the mounting members 43 and 44 and the auxiliary grip 46 could be sized and shaped to allow auxiliary handles 18 on adjacent tool handle assemblies 1 to nest together. More specifically, the support arms could angle inward from a base end to the distal end to which the auxiliary grip 46 is attached and the auxiliary grip 46 of each auxiliary handle 18 is narrower than the distance between first and second legs 21 and 22. The narrower auxiliary grip 46 of a first tool handle assembly 1 then fits between the first and second legs 21 and 22 of a second tool handle assembly 1 positioned over the first tool handle assembly 1 and between the angled portion of the support arms 43 and 44.

It is to be understood that while certain forms of the present invention have been illustrated and described herein, it is not to be limited to the specific forms or arrangement of parts described and shown.

We claim:

1. A tool comprising:
a tool head having a first handle mounting sleeve and a second handle mounting sleeve disposed on opposite sides thereof; and
a tool handle comprising:
a primary grip;
a first and second leg, each of said legs having a first end, a second end and a middle portion, said first end of said first leg received by said first handle mounting sleeve and said first end of said second leg received by said second handle mounting sleeve such that said first and second legs extend outwardly from the tool head in generally parallel relation to one another; said primary grip connected between said second ends of said legs; and
an auxiliary handle assembly comprising a first and second mounting member each having a semi-enclosed base and a support arm extending outwardly therefrom;
said first mounting member support arm and said second mounting member support arm securing an auxiliary grip therebetween; wherein said first mounting member base slidably receives said first leg and said second mounting member base slidably receives said second leg.

2. The tool handle of the tool as in claim 1, wherein said middle portions of each of said legs are cylindrical and said semi-enclosed base of each said first and second mounting members is semi-cylindrical.

3. The tool handle of the tool as in claim 1, wherein said semi-enclosed base of each of said first and second mounting members comprises a first and second finger on opposite sides of said support arm curving in a first direction and a palm portion curving in a second direction.

4. The tool handle of the tool as in claim 3 wherein said semi-enclosed base of each of said first and second mounting members is securable to a respective first and second leg by securing a pin through a hole in said base and an aligned hole in said leg, said aligned hole in said leg selected from one of a plurality of holes formed in said leg.

5. The tool handle of the tool as in claim 1 wherein said auxiliary handle assembly is removable from said first and second legs.

6. The tool handle of the tool as in claim 1, wherein when said first and second legs are received in said respective first and second mounting member bases of said auxiliary handle assembly, said auxiliary grip is spaced outward from said first and second legs and generally transverse thereto in a use position; and said auxiliary handle assembly is selectively securable between said first and second legs in a stowed position such that said auxiliary grip generally extends in planar alignment with said first and second legs after first separating said first and second mounting member bases from said first and second legs.

7. The tool handle of the tool as in claim 6 wherein said first ends of said first and second legs form an auxiliary handle assembly receiving area therebetween for receiving said auxiliary handle in said stowed position.

8. The tool handle of the tool as in claim 1 wherein said tool handle comprises a first tool handle having an auxiliary grip that is narrower than the spacing between said first and second legs such that said auxiliary grip fits between first and second legs of a second tool handle positioned over said first tool handle.

9. The tool as in claim 1 wherein said tool head comprises a shovel blade.

10. A tool comprising:
a tool head; and
a tool handle comprising:
a primary grip;
a first and second leg, each of said legs having a first end, a second end and a middle portion, said first ends of said first and second legs being secured to the tool head such that said first and second legs extend outwardly from the tool head in generally parallel relation to one another; said primary grip connected between said second ends of said legs;
an auxiliary handle assembly comprising a first and second mounting member each having a semi-cylindrical base forming a leg receiving area and a support arm extending outwardly therefrom; said first mounting member support arm and said second mounting member support arm securing an auxiliary grip therebetween;
wherein said first mounting member base slidably receives said middle portion of said first leg therethrough and said second mounting member base slidably receives said middle portion of said second leg therethrough; and
wherein said middle portion of each of said legs is inwardly offset from said first and second ends of each of said legs.

11. The tool handle of the tool as in claim 10, wherein said semi-cylindrical base of each said first and second mounting members comprise a first and second finger on opposite sides of said support arm curving in a first direction and a palm portion curving in a second direction.

12. The tool handle of the tool as in claim 10, wherein when said first and second legs are received in said respective first and second mounting member bases of said auxiliary handle assembly, said auxiliary grip is spaced outward from said first and second legs and generally transverse thereto in a use position; and said auxiliary handle assembly is selectively securable between said first and second legs in a stowed position such that said auxiliary grip generally extends in planar alignment with said first and second legs after first separating said first and second mounting member bases from said first and second legs.

13. The tool head of the tool as in claim 10, said tool head having a front and a rear; and wherein said first ends of said first and second legs are secured to said front of said tool head.

14. The tool handle of the tool as in claim 10, wherein said semi-enclosed base of each of said first and second mounting members is securable to a respective first and second leg by securing a pin through a hole in said base and an aligned hole in said leg, said aligned hole in said leg selected from one of a plurality of holes formed in said leg.

15. The tool handle of the tool as in claim 10, wherein said auxiliary handle assembly is removable.

16. The tool handle of the tool as in claim 15, wherein said first and second legs form an auxiliary handle assembly receiving area therebetween for receiving said auxiliary handle in said stowed position.

17. The tool as in claim 10 wherein said tool head comprises a shovel blade.

18. The tool handle of the tool as in claim 10 wherein said tool handle comprises a first tool handle having an auxiliary grip that is narrower than the spacing between said first and second legs such that said auxiliary grip fits between first and second legs of a second tool handle positioned over said first tool handle.

19. A tool handle comprising:
a primary grip;
an auxiliary handle assembly comprising a first and second mounting member each having a semi-cylindrical base and a support arm extending outwardly therefrom;
said first mounting member support arm and said second mounting member support arm securing an auxiliary grip therebetween;
a first and second leg, each of said legs having a first end, a second end and a middle portion; wherein said primary grip is connected between said second ends of said legs;
wherein said first mounting member semi-cylindrical base slidably receives said middle portion of said first leg and said second mounting member base slidably receives said middle portion of said second leg; and
wherein said middle portion of each of said legs is inwardly offset from said first and second ends of each of said legs.

20. The tool handle as in claim 19, wherein said semi-enclosed base of each of said first and second mounting members comprises a first and second finger on opposite sides of said support arm curving in a first direction and a palm portion curving in a second direction.

21. The tool handle of the tool as in claim 19, wherein said semi-enclosed base of each of said first and second mounting members is securable to a respective first and second leg by securing a pin through a hole in said base and an aligned hole in said leg, said aligned hole in said leg selected from one of a plurality of holes formed in said leg.

22. The tool handle as in claim 19 in combination with a tool head.

23. The tool handle in combination with the tool head as in claim 22 wherein said tool head comprises a shovel blade.

24. The tool handle as in claim 19 wherein said auxiliary handle assembly is removable.

25. The tool handle as in claim 24 wherein when said first and second legs are received in said respective first and second mounting member bases of said auxiliary handle assembly, said auxiliary grip is spaced outward from said first and second legs and generally transverse thereto in a use position; and said auxiliary handle assembly is selectively securable between said first and second legs in a stowed position such that said auxiliary grip generally extends in planar alignment with said first and second legs after first separating said first and second mounting member bases from said first and second legs.

26. The tool handle of the tool as in claim 19 wherein said tool handle comprises a first tool handle having an auxiliary grip that is narrower than the spacing between said first and second legs such that said auxiliary grip fits between first and second legs of a second tool handle positioned over said first tool handle.

27. A tool handle comprising:
a primary grip;
a first and second leg, each of said legs having a first end, a second end and a middle portion; wherein said primary grip is connected between said second ends of said legs;
an auxiliary handle assembly comprising a first and second mounting member each having a semi-cylindrical base and a support arm extending outwardly therefrom;
said first mounting member support arm and said second mounting member support arm securing an auxiliary grip therebetween;
wherein said auxiliary handle assembly is selectively securable in a use position or a stow position; in said use position, said first mounting member semi-cylindrical base slidably receives said middle portion of said first leg and said second mounting member base slidably receives said middle portion of said second leg such that said auxiliary grip is spaced outward from said first and second legs and generally transverse thereto; and in said stow position, said auxiliary handle assembly is securable between said first and second legs in a stowed position such that said auxiliary grip generally extends in planar alignment with said first and second legs.

28. The tool handle as in claim 27, wherein said semi-cylindrical base of each of said first and second mounting members comprises a first and second finger on opposite sides of said support arm curving in a first direction and a palm portion curving in a second direction.

29. The tool handle of the tool as in claim 27, wherein said semi-cylindrical base of each of said first and second mounting members is securable in said use position to a respective first and second leg by securing a pin through a hole in said base and an aligned hole in said leg, said aligned hole in said leg selected from one of a plurality of holes formed in said leg.

30. The tool handle of the tool as in claim 27, wherein said middle portion of each of said legs is inwardly offset from said first and second ends of each of said legs.

31. The tool handle as in claim 27 in combination with a tool head secured to said first ends of said first and second legs.

32. The tool handle in combination with the tool head as in claim 31, wherein said tool head comprises a shovel blade.
